(19) United States
(12) Patent Application Publication
(10) Pub. No.: US 2008/0254777 A1
(43) Pub. Date: Oct. 16, 2008

(54) SYSTEMS AND METHODS FOR FACILITATING AUTOMATIC GENERATION OF METADATA ABOUT DATA THAT IS COLLECTED BY A MOBILE DEVICE

(75) Inventors: Kenneth A. Arneson, West Richland, WA (US); Sy Prestwich, Riverton, UT (US); James R. Baker, Leesburg, VA (US)

Correspondence Address: MADSON & AUSTIN, 15 WEST SOUTH TEMPLE, SUITE 900, SALT LAKE CITY, UT, 84101, US

(73) Assignee: S5 Wireless, Inc., Sandy, UT (US)

(21) Appl. No.: 11/733,653

(22) Filed: Apr. 10, 2007

(51) Int. Cl. H04M 3/42

(52) U.S. Cl. 455/414.2; 455/556.1

(57) ABSTRACT

A mobile device that facilitates automatic generation of metadata about data that is collected by the mobile device may include a processor and memory in electronic communication with the processor. Instructions may be stored in the memory. The instructions may be executable to collect data and to create an identifier that corresponds to the data that is collected. The instructions may also be executable to transmit a wireless communication signal that comprises the identifier. Transmitting the wireless communication signal may facilitate communication of the identifier to a location and telemetry system and may facilitate determination of metadata about the data by the location and telemetry system.

### TECHNICAL FIELD

The present disclosure relates generally to computers and computer-related technology. More specifically, the present disclosure relates to mobile computing devices and data that is collected by such devices.

### BACKGROUND

The term “mobile computing device” (or simply “mobile device”) may refer to many different types of devices. One example of a mobile device is an imaging device, which may be a digital still camera, a digital video camera, a webcam, etc. Another example of a mobile device is a mobile sensor. Other examples of mobile devices include laptop computers, cell phones, smart phones, personal digital assistants (PDAs), handheld game consoles, etc. Mobile devices are widely used in today's society.

Mobile devices may be used to collect many different kinds of data. For example, imaging devices may be used to capture digital media content, such as still photographs in a digital format, full-motion video (and possibly audio as well) in a digital format, etc. As another example, mobile sensors may also be used to collect data. For example, temperature sensors may collect temperature data, pressure sensors may collect pressure data, etc. There are many other examples of data that may be collected by mobile devices.

The term “metadata” has several definitions, but it may generally be thought of as data that supplements other data. Metadata may be generated for virtually any type of data that is collected by a mobile device. Some examples of metadata that may be generated for a particular set of data include the date and time that the data was captured, the location where the data was captured, etc. Metadata about a particular set of data may be stored internally (i.e., in the same file(s) as the data) or externally (i.e., in one or more files that are separate from the data).

As mentioned, the present disclosure relates to mobile computing devices and data that is collected by such devices. More specifically, the present disclosure relates to systems and methods for facilitating automatic generation of metadata about data that is collected by a mobile computing device.

### BRIEF DESCRIPTION OF THE DRAWINGS

FIG. 1 illustrates some aspects of a system for facilitating automatic generation of metadata about data that is collected by a mobile device;

FIG. 2 illustrates some additional aspects of the system of FIG. 1;

FIG. 3 illustrates some additional aspects of the system of FIG. 1;

FIG. 4 illustrates some additional aspects of the system of FIG. 1;

FIG. 5 illustrates some aspects of another system for facilitating automatic generation of metadata about data that is collected by a mobile device;

FIG. 6 illustrates a method for facilitating automatic generation of metadata about data that is collected by a mobile device;

FIG. 7 illustrates another method for facilitating automatic generation of metadata about data that is collected by a mobile device; and

FIG. 8 illustrates components that may be utilized in a computing device.

### DETAILED DESCRIPTION

A mobile device that facilitates automatic generation of metadata about data that is collected by the mobile device is disclosed. The mobile device may include a transmitter that is configured to transmit wireless communication signals. The mobile device may also include one or more data collection components. The mobile device may also include a processor, and memory in electronic communication with the processor. Instructions may be stored in the memory. The instructions may be executable to collect data, and to create an identifier that corresponds to the data that is collected. The identifier may be created automatically in response to the data being collected. The identifier may be uniquely associated with the data. The instructions may also be executable to transmit a wireless communication signal that includes the identifier. Transmitting the wireless communication signal may facilitate communication of the identifier to a location and telemetry system, and may facilitate determination of metadata about the data by the location and telemetry system. The metadata may include location information about the mobile device when the data was collected.

Creating the identifier may involve processing a data file that includes the data in accordance with a hash algorithm in order to obtain a hash value. The identifier may include the hash value. The identifier may be stored in an identifier file that is separate from a data file that includes the data. Alternatively, the instructions may be executable to embed the identifier within a data file that includes the data.

User input may be received to upload the data file to another computer system. If the identifier is stored in an identifier file, the instructions may be executable to automatically upload the identifier file in addition to the data file.

The wireless communication signal may be received by a plurality of base stations. The base stations may transmit the identifier to the location and telemetry system. Each of the plurality of base stations may transmit a timestamp to the location and telemetry system. The timestamp that is transmitted by a particular base station may indicate when the wireless communication signal was received by the base station.

The wireless communication signal may be a burst direct sequence spread spectrum radio signal. The wireless communication signal may be transmitted automatically in response to the data being collected.

A location and telemetry system that facilitates automatic generation of metadata about data that is collected by a mobile device is disclosed. The location and telemetry system may include a processor, and memory in electronic communication with the processor. Instructions may be stored in the memory. The instructions may be executable to receive an identifier for data. The identifier may be created by a mobile device that collected the data. The identifier may be uniquely associated with the data. The identifier may include a hash value. The instructions may also be executable to receive information that enables the location and telemetry system to determine metadata about the data, and to use the received information to determine the metadata about the data. The instructions may also be executable to provide the metadata that is determined about the data to a requesting computer system. The metadata may be provided in response to receiving a metadata request from the requesting computer system. The requesting computer system may be a system that facilitates management of media files via the Internet.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

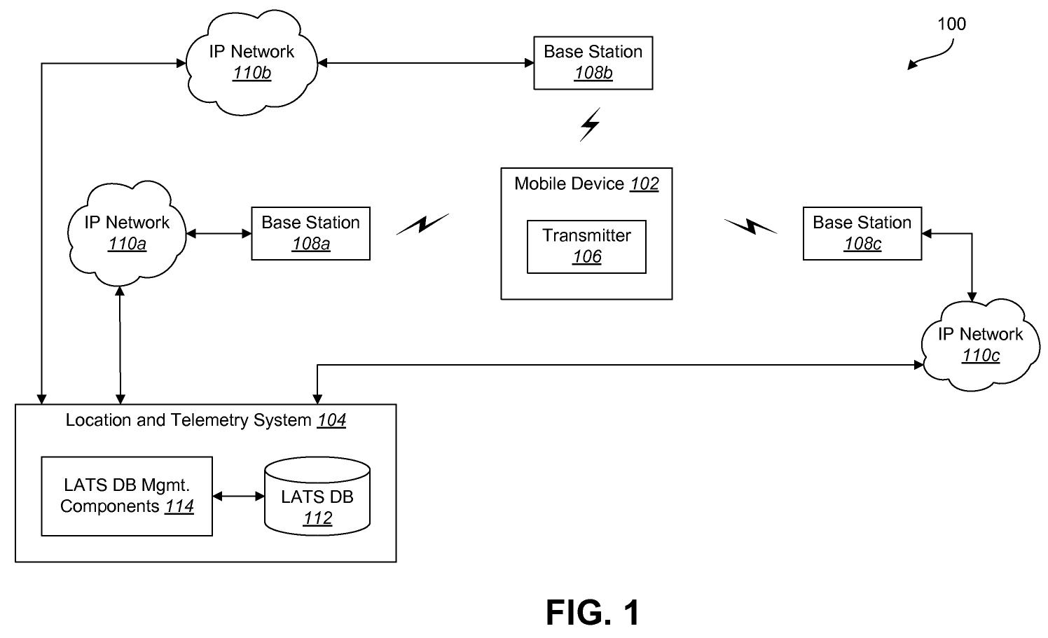

FIGS. 1-4 illustrate a system 100 for facilitating automatic generation of metadata about data that is collected by a mobile device. Referring initially to FIG. 1, the system 100 may include a mobile computing device 102, which may be referred to herein simply as a mobile device 102. As mentioned above, the mobile device 102 may be an imaging device (e.g., a digital still camera, a digital video camera, a webcam, etc.), a mobile sensor, a laptop computer, a cell phone, a smart phone, a personal digital assistant (PDA), a handheld game console, etc.

The system 100 may also include a location and telemetry system 104. The location and telemetry system 104 may be configured to gather and report information about various devices, such as the mobile device 102.

The system 100 may include several components that enable the location and telemetry system 104 to gather information about the mobile device 102, including information about data that is collected by the mobile device 102. For example, the mobile device 102 may be provided with a transmitter 106 that is configured to transmit wireless communication signals. Under some circumstances, the transmitter 106 may be referred to as a tag.

While the transmitter 106 is transmitting wireless communication signals, the mobile device 102 may be located in an area where one or more base stations 108 are within the range of the transmitter 106. In FIG. 1, three base stations 108 are shown within the range of the transmitter 106, namely a first base station 108a, a second base station 108b, and a third base station 108c. Each wireless communication signal that is transmitted by the transmitter 106 may be received and processed by all of the base stations 108 that are within the range of the transmitter 106.

The transmitter 106 may be configured to transmit burst direct sequence spread spectrum (DSSS) radio signals. Additional details about the transmission of the burst DSSS radio signals, and about how these signals may be processed by the base stations 108, may be found in U.S. patent application Ser. No. 11/140,081, titled “Burst Spread Spectrum Radio System And Method For Asset Tracking And Data Telemetry,” filed May 27, 2005, with inventors Sy Prestwich, Scott Bevan, Dirk Ostermiller, and K. Deric Eldredge (hereinafter, “the '081 application”). The '081 application is assigned to the assignee of the present application, and is hereby incorporated by reference in its entirety.

Each base station 108 may be in electronic communication with the location and telemetry system 104. Communication between the base stations 108 and the location and telemetry system 104 may occur via one or more computer networks 110. The networks 110 may operate in accordance with the Internet protocol (IP), and therefore may be referred to herein as IP networks 110. In FIG. 1, the first base station 108a is shown in electronic communication with the location and telemetry system 104 via a first IP network 110a, the second base station 108b is shown in electronic communication with the location and telemetry system 104 via a second IP network 110b, and the third base station 108c is shown in electronic communication with the location and telemetry system 104 via a third IP network 110c.

The location and telemetry system 104 may include a database 112, which may be referred to herein as a location and telemetry system (LATS) database 112. The LATS database 112 may be used to store information gathered by the location and telemetry system 104. One or more components 114 of the location and telemetry system 104 may be used to manage the LATS database 112. These components 114 may be referred to herein as LATS database management components 114.

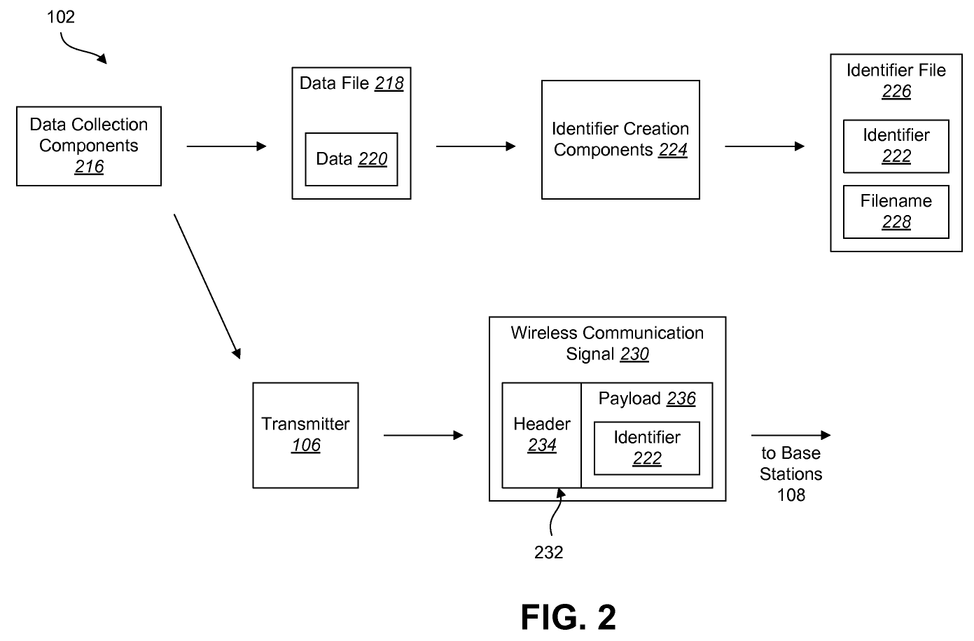

Referring now to FIG. 2, the mobile device 102 may be used to collect data 220. The components 216 within the mobile device 102 that perform the function of collecting data 220 may be referred to herein as data collection components 216. For example, if the mobile device 102 is an imaging device, the imaging device may be used to capture digital media content (such as digital images, digital video, etc.), and the data collection components 216 may include a lens, an aperture, a digital shutter, an image sensor, read-out circuitry, etc.

When data 220 is collected by the mobile device 102, a data file 218 may be created. The data file 218 may include the data 220 that is collected.

When a data file 218 is created, an identifier 222 for the data file 218 may be created. The identifier 222 may be automatically created in response to the data file 218 being created. In other words, once the data file 218 is created, the identifier 222 may be created without the need for the user of the mobile device 102 to initiate creation of the identifier 222 as a separate step. As will be explained in greater detail below, the identifier 222 may be used to associate metadata about the data file 218 with the data file 218 itself. The component(s) 224 within the mobile device 102 that create an identifier 222 for the data file 218 may be referred to herein as identifier creation components 224.

There are many ways that an identifier 222 may be created for a data file 218. For example, the data file 218 may be processed in accordance with a hash algorithm, thereby creating a hash value that is uniquely associated with the data file 218. This hash value may be used as the identifier 222 for the data file 218.

Where an identifier 222 for a data file 218 is created by processing the data file 218 in accordance with a hash algorithm, there are many different hash algorithms that may be used. For example, one of the Secure Hash Algorithm (SHA) family of hash algorithms (e.g., SHA-1, SHA-224, SHA-256, SHA-384, and SHA-512) may be used. As another example, the Message-Digest algorithm 5 (MD5) may be used.

The identifier 222 that is created for a particular data file 218 may be uniquely associated with the data file 218. An identifier may be “uniquely associated” with a data file 218 if the process that was used to create the identifier is such that it would be statistically improbable that two identical identifiers 222 would be created for two different data files 218. A hash value that is created by processing a data file 218 in accordance with a hash algorithm is one example of an identifier 222 that may be considered to be uniquely associated with a data file 218.

An identifier file 226 may be created to store the identifier 222 that is created. The filename 228 of the data file 218 which the identifier 222 corresponds to may also be stored in the identifier file 226.

Once the identifier 222 for the data file 218 has been created, the mobile device 102 may transmit a wireless communication signal 230 that includes the identifier 222. As will be explained below, transmitting the identifier 222 in a wireless communication signal 230 may facilitate communication of the identifier 222 to the location and telemetry system 104. Transmitting the identifier 222 in a wireless communication signal 230 may also facilitate the determination of metadata about the data file 218 by the location and telemetry system 104.

The wireless communication signal 230 that is transmitted by the mobile device 102 may include a packet 232. The packet 232 may include a header portion 234 and a payload portion 236. The identifier 222 may be included within the payload portion 236 of the packet 232.

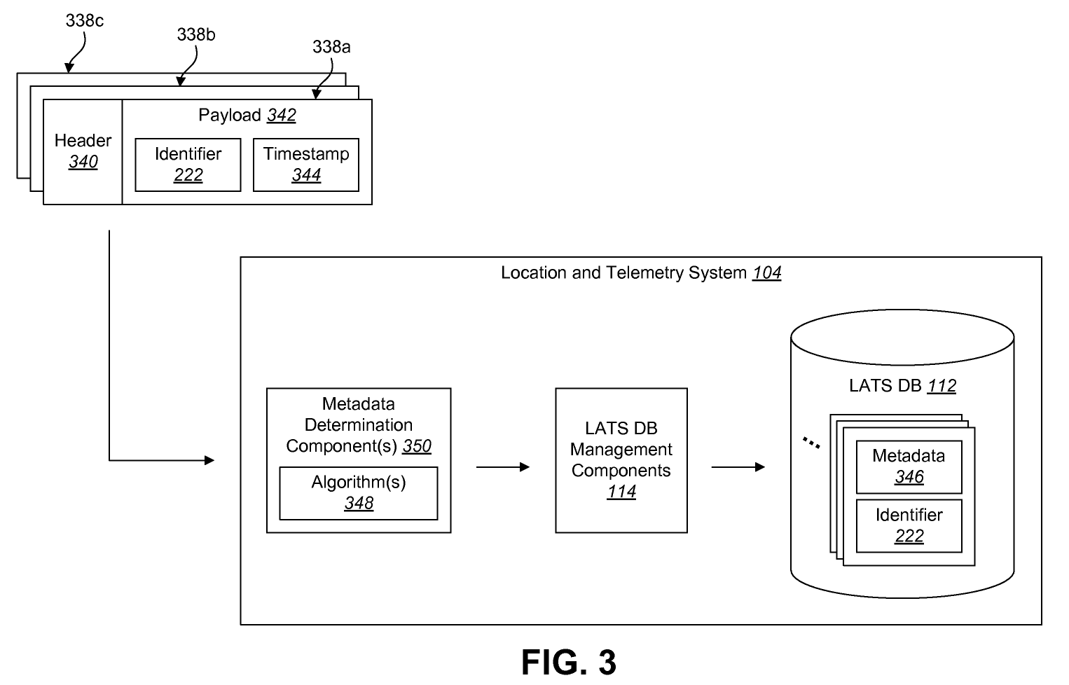

Each base station 108 that is within the range of the mobile device's transmitter 106 may receive the wireless communication signal 230. Referring now to FIG. 3, each base station 108 may then send a packet 338 to the location and telemetry system 104 via an IP network 110. The packet 338 that a particular base station 108 sends to the location and telemetry system 104 may be similar to the packet 232 that the base station 108 received from the mobile device 102. In particular, the packet 338 may include a header portion 340 and a payload portion 342, and the payload portion 342 may include the identifier 222 that corresponds to the data file 218. In addition, the packet 338 may include a timestamp 344 in the payload portion 342. The timestamp 344 may indicate the time at which the wireless communication signal 230 sent from the mobile device 102 was received by the base station 108.

Because each base station 108 that is within the range of the transmitter 106 may send a packet 338 to the location and telemetry system 104, the location and telemetry system 104 may receive multiple packets 338 (in particular, a separate packet 338 from each base station 108 that is within the range of the transmitter 106). For example, the location and telemetry system 104 may receive a first packet 338a from the first base station 108a via the first IP network 110a, a second packet 338b from the second base station 108b via the second IP network 110b, and a third packet 338c from the third base station 108c via the third IP network 110c. The header portion 340 and payload portion 342 of the first packet 338a are shown in FIG. 3.

The timestamps 344 in the packets 338 may enable the location and telemetry system 104 to determine metadata 346 about the data file 218. Thus, upon receiving the packets 338 from the base stations 108, the location and telemetry system 104 may determine metadata 346 about the data file 218 by processing the received timestamps 344 in accordance with one or more predefined algorithms 348. The component(s) 350 that implement this functionality may be referred to as metadata determination components 350. The metadata 346 that is determined may include location information about the mobile device 102 at the time when the data file 218 was created.

The metadata 346 that is determined about the data file 218 may be stored in the LATS database 112. The identifier 222 corresponding to the data file 218 may also be stored in the LATS database 112. The metadata 346 and the identifier 222 may be associated with one another in the LATS database 112. The LATS database management components 114 may be utilized to perform these operations.

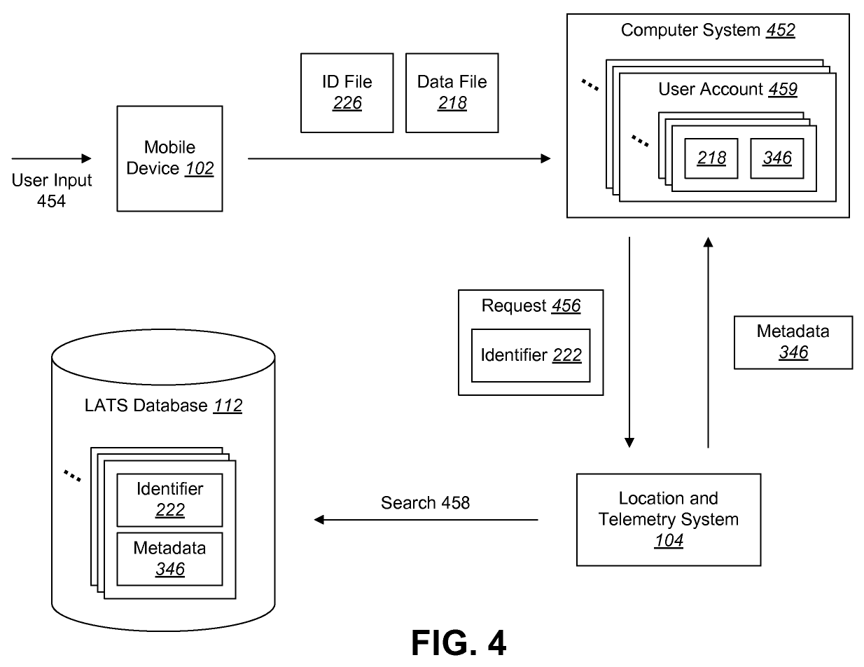

Referring now to FIG. 4, at some point a user of the mobile device 102 may wish to upload the data file 218 from the mobile device 102 to another computer system 452. The computer system 452 may be a personal computer. Alternatively, the computer system 452 may be a system that facilitates the management of files via the Internet. Where the data file 218 includes digital media content, the computer system 452 may be an online media storage system such as Flickr, Google, or the like.

To upload the data file 218 to another computer system 452, the mobile device 102 may be placed in electronic communication with the desired computer system 452. Communication between the mobile device 102 and the computer system 452 may occur via one or more computer networks (not shown). For example, communication between the mobile device 102 and the computer system 452 may occur via the Internet.

In response to user input 454, the data file 218 on the mobile device 102 may be uploaded to the computer system 452. When the data file 218 is uploaded to the computer system 452, the identifier file 226 may also be uploaded to the computer system 452. This may be done automatically, in response to the data file 218 being uploaded to the computer system 452. The identifier file 226 may be uploaded to the computer system 452 together with (e.g., at substantially the same time as) the data file 218. Alternatively, the identifier file 226 may be uploaded to the computer system 452 separately from (e.g., either before or after) the data file 218.

Upon receiving the data file 218, the computer system 452 may determine that a request 456 for metadata 346 corresponding to the data file 218 should be made from the location and telemetry system 104. There are a variety of ways that the computer system 452 may make this determination. For example, the identifier file 226 or the data file 218 may include a reference to (e.g., a uniform resource locator (URL) corresponding to) the location and telemetry system 104. As another example, the mobile device 102 may send a message to the computer system 452 instructing it to make a request 456 for metadata 346 from the location and telemetry system 104.

In response to determining that a request 456 for metadata 346 should be made from the location and telemetry system 104, the computer system 452 may send a request 456 to the location and telemetry system 104 for the metadata 346 that is associated with the data file 218. The request 456 may be sent to the location and telemetry system 104 via one or more computer networks (not shown). For example, the request 456 may be sent to the location and telemetry system 104 via the Internet.

The request 456 that the computer system 452 sends to the location and telemetry system 104 may include the identifier 222 for the data file 218. Upon receiving the request 456, a search 458 of the LATS database 112 may be conducted for the metadata 346 that is associated with the identifier 222 in the received request 456. If the metadata 346 is located in the LATS database 112, it may be sent back to the requesting computer system 452.

The computer system 452 may store the metadata 346 that it receives from the location and telemetry system 104. The metadata 346 that is generated for the data file 218 may be associated with the data file 218 in a database (not shown) that is part of or accessible to the computer system 452.

As mentioned, the computer system 452 may be a system that facilitates the management of files via the Internet. For example, where the data file 218 includes digital media content, the computer system 452 may be an online media storage system such as Flickr, Google, or the like. Where the computer system 452 facilitates file management via the Internet, all of the metadata 346 that is related to the mobile device 102 (e.g., all of the metadata 346 that is generated for data files 218 that are created by the mobile device 102) may be associated with a user account 459 that corresponds to the mobile device 102.

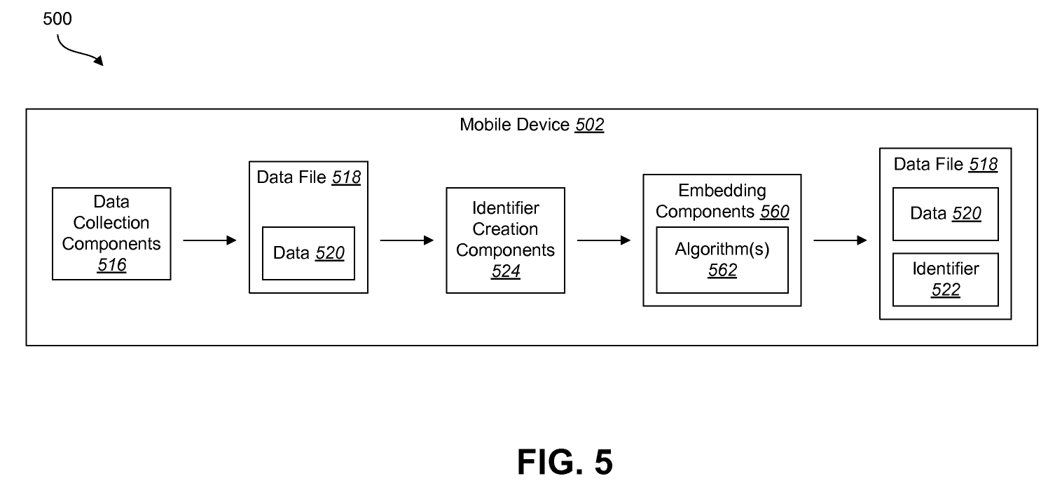

FIG. 5 illustrates another system 500 for facilitating automatic generation of metadata about data that is collected by a mobile device. The system 500 shown in FIG. 5 may be similar in some respects to the system 100 that was described above in connection with FIGS. 1-4. For example, the system 500 may include a mobile device 502. When data 520 is collected by the mobile device 502, a data file 518 may be created. The data file 518 may include the data 520. In response to the data file 518 being created, an identifier 522 for the data file 518 may be created. The components 524 that implement this functionality may be referred to as identifier creation components 524.

In the depicted system 500, instead of storing the identifier 522 in a separate identifier file, the identifier 522 may be embedded within the data file 518 itself. The component(s) 560 within the mobile device 502 that implement this functionality may be referred to as embedding components 560. The embedding components 560 may embed the identifier 522 within the data file 518 in accordance with one or more predefined embedding algorithms 562.

In the depicted system 500, if the data file 518 is ever uploaded to another computer system, it is not necessary to upload a separate identifier file to the computer system. This is because the identifier 522 may be embedded within the data file 518 itself, rather than stored in a separate identifier file.

The operation of the system 500 may be otherwise similar to the system 100 that was described above in connection with FIGS. 1-4. Once the identifier 522 for the data file 518 has been created, the mobile device 502 may transmit a wireless communication signal that includes the identifier 522. This may facilitate communication of the identifier 522 to a location and telemetry system, and may also facilitate the determination of metadata about the data file 518 by the location and telemetry system, in the manner described above.

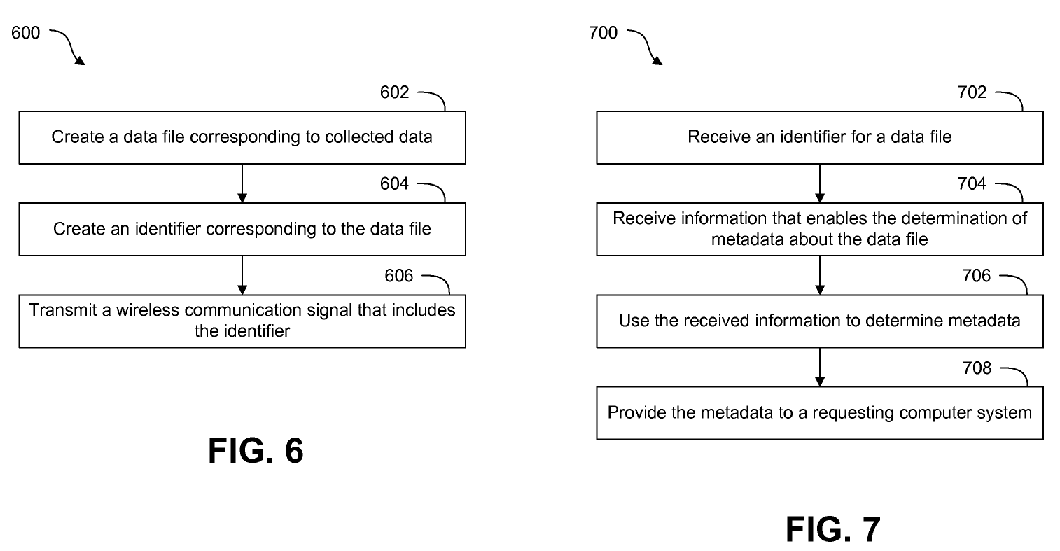

FIG. 6 illustrates a method 600 for facilitating automatic generation of metadata about data that is collected by a mobile device. The method 600 shown in FIG. 6 may be implemented by a mobile device 102.

The method 600 may involve creating 602 a data file 218 corresponding to data 220 that has been collected. The method 600 may also involve creating 604 an identifier 222 corresponding to the data file 218. The identifier 222 may be automatically created in response to the data file 218 being created. Also, the identifier 222 may be uniquely associated with the data file 218. The identifier 222 may be stored in an identifier file 226 that is separate from the data file 218. Alternatively, the identifier 222 may be embedded within the data file 218 itself.

The method 600 may also involve transmitting 606 a wireless communication signal 230 that includes the identifier 222. Transmitting 606 a wireless communication signal 230 that includes the identifier 222 may have the effect of facilitating communication of the identifier 222 to a location and telemetry system 104. As discussed above, the wireless communication signal 230 may be received by the base stations 108 that are within the range of the mobile device's transmitter 106, and these base stations 108 may forward the identifier 222 to the location and telemetry system 104 via an IP network 110.

Transmitting 606 a wireless communication signal 230 that includes the identifier 222 may also have the effect of facilitating determination of metadata 346 about the data file 218 by the location and telemetry system 104. As discussed above, each base station 108 that receives the wireless communication signal 230 may transmit a timestamp 344 to the location and telemetry system 104 that indicates when the wireless communication signal 230 was received by the base station 108. The location and telemetry system 104 may use the received timestamps 344 to determine metadata 346 about the data file 218.

FIG. 7 illustrates another method 700 for facilitating automatic generation of metadata about data that is collected by a mobile device. The method 700 shown in FIG. 7 may be implemented by a location and telemetry system 104.

The method 700 may involve receiving 702 an identifier 222 for a data file 218. As discussed above, the mobile device 102 that created the data file 218 may create an identifier 222 for the data file 218. The mobile device 102 may also transmit a wireless communication signal 230 that includes the identifier 222. The wireless communication signal 230 may be received by several base stations 108, each of which may forward the identifier 222 to the location and telemetry system 104.

The method 700 may also involve receiving 704 information that enables the determination of metadata 346 about the data file 218, and using 706 the received information to determine metadata 346 about the data file 218. For example, each base station 108 that receives the wireless communication signal 230 may transmit a timestamp 344 to the location and telemetry system 104 that indicates when the wireless communication signal 230 was received by the base station 108. The location and telemetry system 104 may process these timestamps 344 in accordance with one or more predetermined algorithms 348 in order to determine metadata 346 about the data file 218. The method 700 may also involve providing 708 the metadata 346 to a requesting computer system 452.

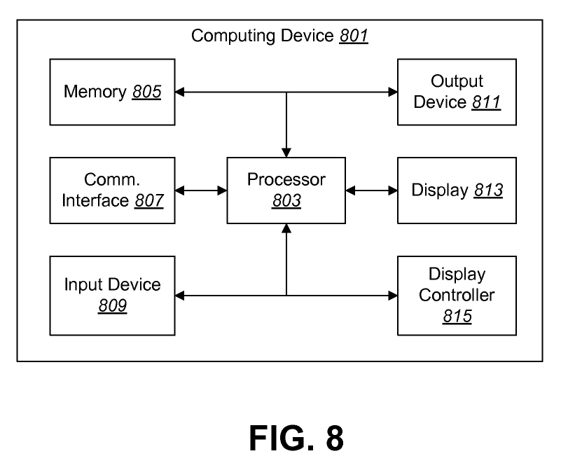

FIG. 8 illustrates components that may be utilized in a computing device 801. The mobile devices 102, 502 and the location and telemetry system 104 may be considered to be computing devices 801.

The computing device 801 may include a processor 803 and memory 805. The processor 803 may perform logical and arithmetic operations based on program instructions, or logical definitions, stored within the memory 805 or circuits contained within the processor 803. The memory 805 may include any electronic component capable of storing electronic information, and may be embodied as read only memory (ROM), random access memory (RAM), magnetic disk storage media, optical storage media, flash memory devices in RAM, on-board memory included with the processor 803, EPROM memory, EEPROM memory, registers, etc. The memory 805 may store program instructions and other types of data. The program instructions may be executed by the processor 803 to implement some or all of the methods disclosed herein.

The computing device 801 may include one or more communication interfaces 807 for communicating with other computing devices. The computing device 801 may also include one or more input devices 809 and one or more output devices 811. One specific type of output device which may be included in the computing device 801 is a display device 813. A display controller 815 may also be provided.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules, circuits and algorithm steps described in connection with the embodiments disclosed herein may be implemented as electronic hardware, computer software or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limiting the scope of the claims.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A mobile device that facilitates automatic generation of metadata about data that is: collected by the mobile device, the mobile device comprising:
a transmitter that is configured to transmit wireless communication signals;
one or more data collection components;
a processor;
memory in electronic communication with the processor; and
instructions stored in the memory, the instructions being executable to:
collect data;
create an identifier that corresponds to the data that is collected; and
transmit a wireless communication signal that comprises the identifier, wherein
transmitting the wireless communication signal facilitates communication of the identifier to a location and telemetry system and facilitates determination of metadata about the data by the location and telemetry system.

2. The mobile device of claim 1, wherein the identifier is automatically created in response to the data being collected.

3. The mobile device of claim 1, wherein the identifier is uniquely associated with the data.

4. The mobile device of claim 1, wherein creating the identifier comprises processing a data file that comprises the data in accordance with a hash algorithm in order to obtain a hash value, and wherein the identifier comprises the hash value.

5. The mobile device of claim 1, wherein the identifier is stored in an identifier file that is separate from a data file that comprises the data.

6. The mobile device of claim 5, wherein in response to user input to upload the data file to another computer system the instructions are also executable to automatically upload the identifier file in addition to the data file.

7. The mobile device of claim 1, wherein the instructions are also executable to embed the identifier within a data file that comprises the data.

8. The mobile device of claim 1, wherein the wireless communication signal is received by a plurality of base stations, and wherein the base stations transmit the identifier to the location and telemetry system.

9. The mobile device of claim 8, wherein each of the plurality of base stations transmits a timestamp to the location and telemetry system, and wherein the timestamp transmitted by a particular base station indicates when the wireless communication signal was received by the base station.

10. The mobile device of claim 1, wherein the wireless communication signal is a burst direct sequence spread spectrum radio signal.

11. The mobile device of claim 1, wherein the wireless communication signal is transmitted automatically in response to the data being collected.

12. The mobile device of claim 1, wherein the metadata comprises location information about the mobile device when the data was collected.

13. A location and telemetry system that facilitates automatic generation of metadata about data that is collected by a mobile device, the location and telemetry system comprising:
a processor;
memory in electronic communication with the processor; and
instructions stored in the memory, the instructions being executable to:
receive an identifier for data, wherein the identifier is created by a mobile device, and wherein the mobile device collected the data;
receive information that enables the location and telemetry system to determine metadata about the data;
use the received information to determine the metadata about the data; and
provide the metadata that is determined about the data to a requesting computer system, wherein the metadata is provided in response to receiving a metadata request from the requesting computer system.

14. The location and telemetry system of claim 13, wherein the identifier is uniquely associated with the data.

15. The location and telemetry system of claim 13, wherein the identifier comprises a hash value.

16. The location and telemetry system of claim 13, wherein the identifier is received from a plurality of base stations, and wherein each of the plurality of base stations received a wireless communication signal comprising the identifier from the mobile device.

17. The location and telemetry system of claim 13, wherein the information comprises a plurality of timestamps, and wherein each timestamp indicates when a base station received a wireless communication signal comprising the identifier from the mobile device.

18. The location and telemetry system of claim 13, wherein the metadata comprises location information about the mobile device when the data was collected.

19. The location and telemetry system of claim 13, wherein the metadata request comprises the identifier for the data.

20. The location and telemetry system of claim 13, wherein the requesting computer system is a system that facilitates management of media files via the Internet.
